(19) United States
(12) Patent Application Publication
(10) Pub. No.: US 2024/0158187 A1
(43) Pub. Date: May 16, 2024

(54) FUNNEL DEVICE FOR COUNTING SYSTEM

(71) Applicants: Pharma Packaging Systems Ltd, Pershore (GB); PallayPack, Kirkland (CA)

(72) Inventors: Ian Barnes, Barton (GB); Louis Pallay, Sainte-Anne-de-Bellevue (CA)

(21) Appl. No.: 18/054,685

(22) Filed: Nov. 11, 2022

(51) Int. Cl. B65G 53/50; B65B 35/12; B65B 57/20; B65G 53/42

(52) U.S. Cl. CPC B65G 53/50; B65B 35/12; B65B 57/20; B65G 53/42; B65G 2207/26

(57) ABSTRACT

A funnel device for a counting system comprising a hollow cylindrical body portion, a tapered funnel portion, at least one inlet port and at least two outlet ports in the cylindrical body portion, and a plurality of vents in the funnel portion. The inlet port of the cylindrical body portion is adapted to receive a pressurized air supply, each outlet port operative to inject a respective high velocity air flow into a first passageway of the cylindrical body portion and to direct the respective air flow downwardly into a second passageway of the funnel portion. The directed air flows create a Venturi effect in the funnel device whereby a speed of flow of the products is increased and a rate of collision of the products is decreased as the products pass through the funnel device.

### TECHNICAL FIELD

The present invention relates generally to dispensing or counting systems, for example in the pharmaceutical industry. More particularly, the invention relates to a funnel device for use in a dispensing or counting system, the design and construction of the funnel device reducing the risk of blockages and stoppages during dispensing and/or counting, thereby improving line speed, efficiency and productivity of the system.

### BACKGROUND

In the pharmaceutical industry, bottle-filling counting machines and systems are well known, specifically high-end and in-motion bottle filling systems that count tablets/capsules/gummies while filling the bottles. The line speed, efficiency and productivity of these systems are critical to client satisfaction but can be hampered by blockages and stoppages, often due to product to neck size ratio (e.g. when a product being filled into a bottle does not flow quickly enough through the bottle neck opening) and/or the nature of the product (e.g. products that are stickier in nature, such as gummies, chewables, capsules, soft gels or hard gels, can merge at the discharge position). In order to reduce the risk of these blockages and stoppages, it becomes necessary to restrict product feed speed and pre-counting or to allow time in the filling parameters, which obviously also reduces productivity.

Conventional and standard counting/dispensing systems or machines traditionally use a chute and funnel arrangement through which the product flows from the system/machine to a bottle or container. The product typically arrives from multiple different positions or channels of the system, all of the channels terminating at the single chute which leads into the funnel for dispensing into the bottle or container. When multiple different channels simultaneously deliver product to a same discharge position of the single chute (e.g. 6 channels delivering/outputting into 1 position), which pours all of the received product through the single funnel into a restricted neck opening of the bottle or container, blockages and stoppages unavoidably arise over time. This problem can be further exasperated by the nature of the product, which may inherently give rise to merging of products when brought into contact. That is, when a product is sticky or adhesive (like a gelatin-based gummy or a gelatin-encased capsule), the simultaneous delivery of multiple such products through a single chute and funnel can be characterized by merging together of multiple ones of the product, which inevitably creates blockages and even possibly stoppages in the operation of the dispensing/counting system or machine.

In order to minimize and deal with such blockages in the conventional counting and dispensing systems or machines, the speed of operation of the system/machine has to be progressively reduced, additional time is required to allow for clearing of the blockage, which can take several minutes to complete. Obviously, after the blockage is cleared, it takes even longer to restart the system. The overall impact of these types of blockages on the system/machine is that speed of operation is limited, in that the average speed at which the machine could run is reduced and/or limited (e.g. 30 bottles per minute instead of 50 bottles per minute). Thus, efficiency and productivity of the system/machine is also reduced and limited.

Prior art solutions include the introduction of vibration to some stage of the transport and transfer of product from machine/system to bottle/container. In one example, the channel tracks on which the product travels to the discharge position (single chute/funnel) are made to vibrate during transport of the product, where this vibration motion can break up merging between products. In another example, the funnel that receives all of the products from the multiple channels at the discharge position is made to vibrate during flow of product there through, also to break up merging between products and help disperse or free blockages. Unfortunately, in the funnel, the transfer of vibration motion to products that are sticky or adherent in nature results in the products becoming compacted, thereby drawn or joined together. Any potential gain of operation acquired from the use of such a vibration motion, whether on a channel track or in the funnel, is lost to a perceived reduction in the size of the bottle or container neck due to the compacting of the product.

In U.S. Pat. No. 5,191,741, an apparatus for counting tablets and feeding a predetermined number of tables to a bottle is disclosed. A fluidized bed of tablets is created above a plurality of slat bars, each of which comprises a plurality of cavities having a vacuum port connected to a source of negative pressure. The vacuum draws individual tablets down from the fluidized bed and into the cavities in the slat bar, thereby completely filling each cavity with a tablet. A positive airflow may be flowed through the vacuum ports to eject the tablets into means for feeding the tablets into bottles.

U.S. Pat. No. 7,753,229 discloses a counter for use with a medication storing and dispensing cassette. The counter has a loader for receiving a cassette, a sensor for sensing whether a cassette is in the loader, means for moving the loader into an operative position, a vacuum unit for applying a vacuum to the cassette, a drive unit for driving a driven portion of the cassette and a counter for counting medication within a portion of the cassette. In one aspect, a rotatable conveying wheel has openings positioned such that a portion of the wheel is in communication with a pick-up area while another portion of the wheel is adjacent to an entrance end of the discharge chute. The venturi design of the openings in the conveying wheel maintains an equivalent airflow and vacuum pressure differential through the openings in the conveying wheel but reduces the airflow turbulence and substantially reduces the audible noise levels.

None of the prior art systems or apparatuses specifically address nor successfully overcome blockages that arise due to nature of the product during product delivery at a discharge position of a counting or dispensing system, where such blockages negatively affect the speed of product flow and thus of system productivity.

Consequently, there exists a need in the industry to provide a funnel device for a counting system that keeps all products flowing at a consistent and repeatable speed at the discharge/dispensing position to allow maximum output from the system.

### SUMMARY

It is an object of the present invention to provide a funnel device for a counting or dispensing system that reduces the occurrence of blockages and stoppages during dispensing, thereby improving line speed, efficiency and productivity of the system.

In accordance with a broad aspect, the present invention provides a funnel device for a counting system comprising a hollow cylindrical body portion, a tapered funnel portion, at least one inlet port and at least two outlet ports in the cylindrical body portion, and a plurality of vents in the funnel portion. The cylindrical body portion comprises an upper end, a lower end, an exterior surface and an interior surface, the upper end of the cylindrical body portion operative to receive a plurality of products, the interior surface of the cylindrical body portion defining a first passageway between the upper and lower ends of the cylindrical body portion through which pass the received products. The funnel portion comprises a top end, a bottom end and an annular peripheral wall, the top end of the funnel portion connected to the lower end of the cylindrical body portion, the annular peripheral wall comprising an inner side and an outer side and extending with a taper angle from the top end of the funnel portion to the bottom end thereof, the inner side of the annular peripheral wall defining a second passageway through which pass the products, the bottom end of the funnel portion operative to output the products into a container positioned below the funnel device. The inlet port of the cylindrical body portion is adapted to receive a pressurized air supply, each outlet port operative to inject a respective air flow into the first passageway proximate to the lower end of the cylindrical body portion and to direct the respective air flow downwardly into the second passageway of the funnel portion, the directed air flow creating a Venturi effect in the funnel device whereby a speed of flow of the products is increased and a rate of collision of the products is decreased as the products pass through the funnel device. Each vent extends between the inner and outer sides of the annular peripheral wall of the funnel portion, the plurality of vents operative to exhaust the air flows from the second passageway of the funnel portion before the air flows reach the bottom end of the funnel portion.

Advantageously, the design of the funnel device with injection of high velocity air flows into the cylindrical portion, and downward directing of these air flows into the specifically tapered funnel portion, gives rise to a Venturi effect within the funnel device. This Venturi effect leads to an increase of the velocity of air flow and a decrease of pressure within the funnel device, which results in an increase of the speed of flow of products as they pass through the funnel device. The directed air flows within the funnel device also mitigate the ricocheting of multiple products simultaneously entering the funnel device from multiple different positions/channels, such that products have much less time to collide and potentially form blockages.

In accordance with another broad aspect, the present invention provides a counting system for counting and dispensing pharmaceutical products, the system comprising, at a discharge position, a funnel device for dispensing products into containers. The funnel device comprises a hollow cylindrical body portion, a tapered funnel portion, at least one inlet port and at least two outlet ports in the cylindrical body portion, and a plurality of vents in the funnel portion. An upper end of the cylindrical body portion is operative to receive a plurality of products, an interior surface of the cylindrical body portion defining a first passageway between upper and lower ends of the cylindrical body portion through which pass the received products. A top end of the funnel portion is connected to the lower end of the cylindrical body portion. An annular peripheral wall of the funnel portion extends with a taper angle from the top end of the funnel portion to a bottom end thereof, an inner side of the annular peripheral wall defining a second passageway through which pass the products, the bottom end of the funnel portion operative to output the products into a container positioned below the funnel device. The inlet port of the cylindrical body portion is adapted to receive a pressurized air flow, each outlet port operative to inject a respective air flow into the first passageway proximate to the lower end of the cylindrical body portion and to direct the respective air flow downwardly into the second passageway of the funnel portion, the directed air flow creating a Venturi effect in the funnel device whereby a speed of flow of the products is increased and a rate of collision of the products is decreased as the products pass through the funnel device. The plurality of vents in the funnel portion are operative to exhaust the air flows from the second passageway of the funnel portion before the air flows reach the bottom end of the funnel portion.

### BRIEF DESCRIPTION OF THE DRAWINGS

The invention will be better understood by way of the following detailed description of embodiments of the invention with reference to the appended drawings, in which:

FIG. 1 is a top perspective view of a funnel device, according to an embodiment of the present invention;

FIG. 2 is a bottom perspective view of the funnel device, according to an embodiment of the present invention;

FIGS. 3A and 3B show a top plane view and a side view, respectively, of the funnel device, according to an embodiment of the present invention;

FIGS. 4A and 4B show a cross-sectional perspective view and a cross-sectional plane view, respectively, of the funnel device along line A-A of FIG. 3B, according to an embodiment of the present invention;

FIG. 5 is an exploded perspective view of the funnel device, according to a non-limiting example of implementation of the present invention; and

FIGS. 6A-6D illustrate a counting machine for dispensing products into bottles, the counting machine incorporating the funnel device of FIG. 1, according to a non-limiting example of implementation of the present invention.

### DETAILED DESCRIPTION

The present invention is directed to a funnel device for a counting or dispensing system, the funnel device operative to keep products flowing at consistent and repeatable speed during dispensing and to allow maximum output from the system.

The funnel device is comprised of a hollow cylindrical body portion and a tapered funnel portion, a top end of the funnel portion being connected to a lower end of the cylindrical body portion. An upper end of the cylindrical body portion is operative to receive a plurality of products, which pass through a first passageway defined by the cylindrical body portion and a second passageway defined by the funnel portion, the latter extending with a taper angle from top end to bottom end. The bottom end of the funnel portion is operative to output the products into a container positioned below the funnel device.

The funnel device also comprises at least one inlet port and at least two outlet ports provided in the cylindrical body portion, the at least one inlet port adapted to receive a pressurized air supply, the at least two outlet ports operative to inject high velocity air flows into the first passageway proximate to the lower end of the cylindrical body portion. These high velocity air flows are directed downwardly into the second passageway of the funnel portion. The directed air flows create a venturi effect in the funnel device, which results in an increased speed of flow of the products and a decreased rate of collision of the products as they pass through the funnel device.

The funnel device further comprises a plurality of vents provided in the funnel portion. The plurality of vents are together operative to exhaust all of the air of the air flows from the second passageway of the funnel portion before the air flows reach the bottom end of the funnel portion, thus preventing the air flows from entering the container located below the funnel device.

As used herein, the terms “counting system”, “dispensing system”, “counting machine” and “dispensing machine” refer to any type of container-filling counting and/or dispensing system, including in-motion bottle filling systems or machines that count tablets/capsules/gummies while filling the bottles, as are well known in the pharmaceutical industry.

As used herein, the term “taper” refers to a reduction in overall diameter over a certain length, while the term “taper angle” refers to a rate at which the taper reduces over the length.

As used herein, the term “port” refers to an opening for intake or exhaust of a fluid.

As used herein, the term “Venturi effect” refers to the well known principle by which the velocity of a fluid passing through a constricted area will increase and its static pressure will decrease, in a situation with constant mechanical energy.

As used herein, the term “vent” refers to an opening that allows a fluid to pass out of or into a confined space.

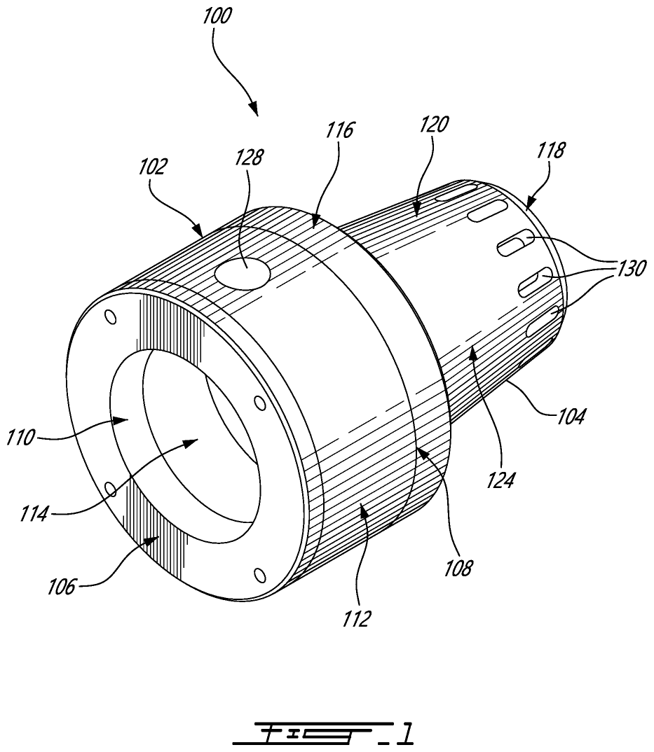

FIGS. 1, 2, 3A and 3B illustrate a funnel device 100, in accordance with an embodiment of the present invention.

The funnel device 100 comprises a hollow cylindrical body portion 102 and a tapered funnel portion 104.

The cylindrical body portion 102 has an upper end 106, a lower end 108, an interior surface 110 and an exterior surface 112. The interior surface 110 defines a first passageway 114 through the cylindrical body portion 102, between the upper and lower ends 106, 108.

The open upper end 106 of the cylindrical body portion 102 provides an entrance to the funnel device 100, and is operative to receive a plurality of products, such as for example tablets, capsules or gummies, that must pass through the funnel device 100.

With reference to FIGS. 1, 2 and 3B, the tapered funnel portion 104 has a top end 116, a bottom end 118 and an annular peripheral wall 120. The annular peripheral wall 120 has an inner side 122 and an outer side 124, and extends with a taper angle from the top end 116 to the bottom end 118 of the funnel portion 104, as will be discussed in further detail below. The inner side 122 of the annular peripheral wall 120 defines a second passageway 126 through the funnel portion 104, between the top and bottom ends 116, 118.

Note that products received in the funnel device 100 will pass through the second passageway 126 of the funnel portion 104 after passing through the first passageway 114 of the cylindrical body portion 102.

The top end 116 of the funnel portion 104 and the lower end 108 of the cylindrical body portion 102 are detachably connected together. Note that different mechanisms for connecting the top end 116 of the funnel portion 104 to the lower end 108 of the cylindrical body portion 102 are possible and included in the scope of the invention. Possible examples of such mechanisms include rivets, bolts, screws, adhesive, among other possibilities.

In a variant embodiment of the invention, the top end 116 of the funnel portion 104 and the lower end 108 of the cylindrical body portion 102 are permanently connected or attached together. Possible examples of mechanisms for permanently connecting the top end 116 of the funnel portion 104 to the lower end 108 of the cylindrical body portion 102 include soldering, welding, bonding and brazing, among other possibilities.

The open bottom end 118 of the funnel portion 104 provides an exit from the funnel device 100 and is operative to output the products that pass through the funnel portion 104, for example into a container that may be positioned below the funnel device 100. This container may be a bottle or a pouch, among other possibilities.

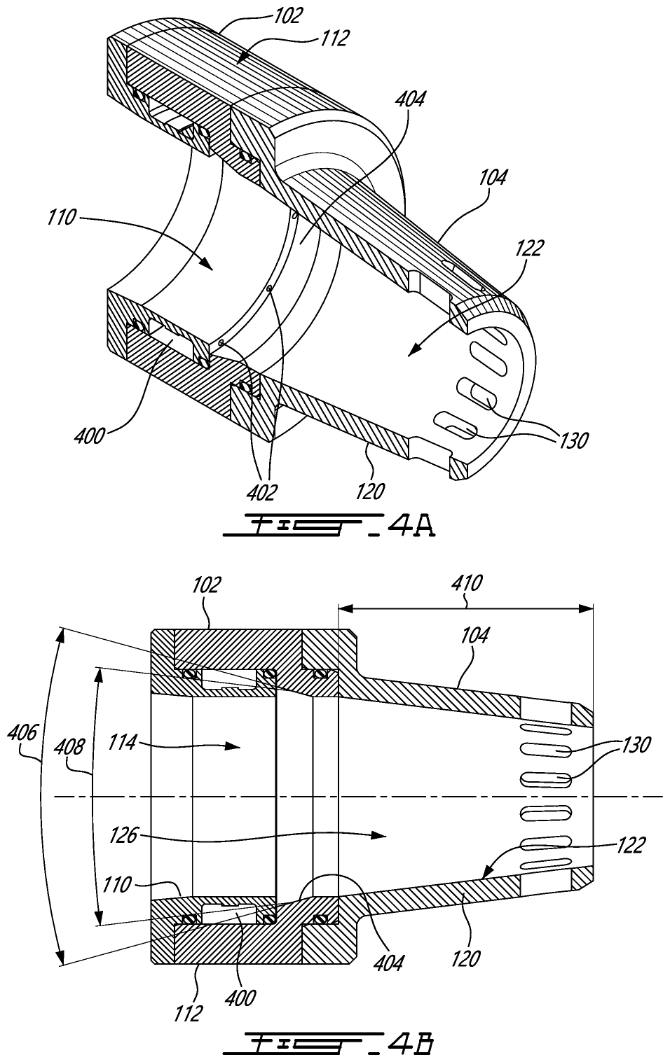

The funnel device 100 comprises at least one inlet port 128 in the cylindrical body portion 102, where this inlet port 128 is adapted to receive a pressurized air supply (not shown). With reference to the cross-sectional views of FIGS. 4A and 4B, the funnel device 100 also comprises at least two outlet ports 402 in the cylindrical body portion 102 proximate to the lower end 108 of the cylindrical body portion 102, which outlet ports 402 are operative to output high velocity air flows and direct these air flows downwardly through the funnel device 100.

As seen in FIGS. 4A and 4B, the cylindrical body portion 102 of the funnel device 100 includes an annular channel 400 that extends along the circumference of the cylindrical body portion 102 between the interior and exterior surfaces 110, 112 thereof. The inlet port 128 feeds into this annular channel 400, which receives the pressurized air and acts as a reservoir. The outlet ports 402 of the cylindrical body portion 102 are in fluid communication with the annular channel 400, extending downwardly from the channel 400 towards the lower end 116 of the cylindrical body portion 102. The annular channel 400 is operative to evenly distribute the pressurized air to the plurality of outlet ports 402, each of which is operative to inject a respective high velocity air flow into the first passageway 114 of the cylindrical body portion 102 proximate to the lower end 108 of the cylindrical body portion 102. These air flows are directed by the outlet ports 402 onto an angled surface 404 of the interior surface 110 of the cylindrical body portion 102, located just above the lower end 108 of the cylindrical body portion 102, which deflects the air flows at high velocity and directs them at a port outlet angle 406 downwardly into the second passageway 126 of the funnel portion 104.

In a specific, non-limiting example of implementation, the plurality of outlet ports 402 of the funnel device 100 are distributed in a spaced-apart manner about the cylindrical body portion 102, such that high velocity air flows are injected into the first passageway 114 at different positions about the circumference of the cylindrical body portion 102 and therefore deflected and directed into the second passageway 126 at different positions about the circumference of the funnel portion 104.

In another specific, non-limiting example of implementation, the port outlet angle 406 of the funnel device 100 defined by the angled surface 404 of the cylindrical body portion 102 is an inclusive angle of 30.75 degrees. However, different port outlet angles are possible and included in the scope of the invention. Notably, the port outlet angle 406 can be varied to suit different configurations of the funnel portion 104 and can be between 10 and 90 degrees.

Specific to the present invention, when air flows are injected into the first passageway 114 and deflected at high velocity off the angled surface 404, directed downwardly at the port outlet angle 406 into the tapered second passageway 126, a Venturi effect is created within the funnel device 100. This Venturi effect gives rise to a decrease in pressure and an increase in velocity of an air flow as it flows through the constricted space of the funnel device 100. Since the directed air flows carry products through the funnel device 100, the speed of flow of the products through the funnel device 100 is also increased. Furthermore, as a plurality of products enter the funnel device 100 via the upper end 106 of the cylindrical body portion 102, possibly arriving simultaneously from multiple different channels/tracks/positions, the products can ricochet and collide. However, the directed air flows within the funnel device 100 mitigate that type of movement by the products, collecting and carrying the products through the funnel device 100 such that the products have much less time to collide. As such, there is also a decreased rate of collision of the products as they flow through the funnel device 100.

The funnel device 100 also comprises a plurality of vents 130 in the funnel portion 104, each vent 130 extending between the inner and outer sides 122, 124 of the annular peripheral wall 120. Note that, since the vents 130 are located in the annular peripheral wall 120, the vents 130 also extend with the same taper angle as that of the annular peripheral wall 120 in the direction of the bottom end 118 of the funnel portion 104.

Specific to the present invention, the plurality of vents 130 are together operative to exhaust or release any air of the directed air flows out of the second passageway 126 of the funnel portion 104 before the air flows reach the bottom end 118 of the funnel portion 104. Note that, since the air of the air flows is exhausted from the funnel device 100 before these air flows reach the bottom end 118 of the funnel portion 104, the air flows are prevented from entering any container or bottle positioned below the funnel device 100; rather, only the products passing through the funnel device 100 will enter the container. This is beneficial since, if air from the air flows were to enter the container, this air would dead end in the container and create a cushion that would stop the products from entering the container.

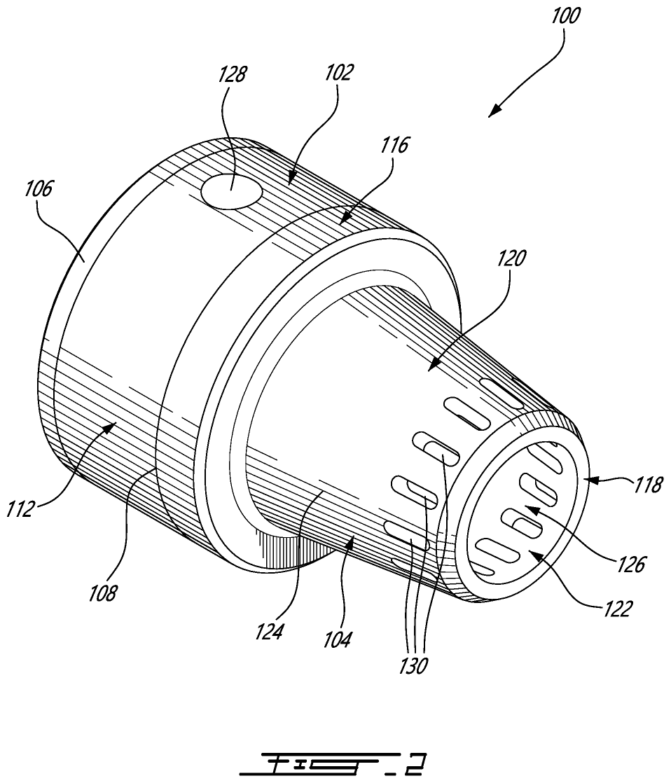

In a specific, non-limiting example of implementation, the vents 130 are oval or rounded rectangular in shape, as seen in FIGS. 1 and 2. Such a shape for the vents 130 allows to vent air without releasing or catching any of the products flowing through the funnel device 100. However, it should be noted that various different shapes of the vents 130 are possible (e.g. circular) and included in the scope of the invention.

In another specific, non-limiting example of implementation, the vents 130 in the funnel portion 104 are distributed evenly, in a spaced-apart manner, about the annular peripheral wall 120, adjacent to the bottom end 118 of the funnel portion 104, as shown in FIGS. 1 and 2. Such a distribution of the vents 130 provides for a balanced venting of the air, more specifically of all of the air, of the air flows directed through the funnel device 100. However, it should be noted that various different distributions and/or positions of the vents 130 on the funnel portion 104 are possible and included in the scope of the invention.

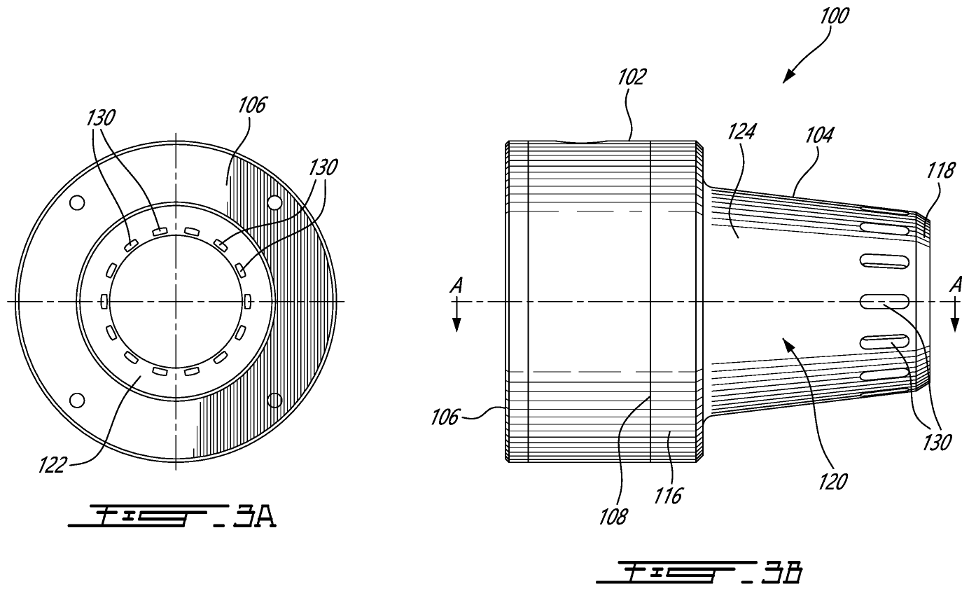

As seen in FIGS. 3B and 4B, the annular peripheral wall 120 of the funnel portion 104 is characterized by a specific taper angle 408 and a specific taper length 410, where this angle and this length influence not only the degree of Venturi effect that arises within the funnel device 100, and thus the increase of velocity of the air flows and product flow through the funnel device 100, but also the effectiveness of the vents 130 to exhaust all of the air of the air flows out of the second passageway 126 before this air reaches the bottom end 118 of the funnel portion 104. The taper angle 408 of the annular peripheral wall 120, and thus of the vents 130, facilitates complete exhausting or release of the air flows from the second passageway 126.

Note that the taper angle 408 and taper length 410 of the funnel portion 104 of the funnel device 100 are variables that are dictated by the product and receptacle, that is by the type/size/shape of the products passing through the funnel device 100 and by the type/size/opening of the container or receptacle receiving the products from the funnel device 100.

In a specific, non-limiting example of implementation, the taper angle 408 of the funnel device 100 is between 10 and 30 degrees inclusively. In another specific, non-limiting example of implementation, the taper length 410 is at least 70 mm in order to ensure that an adequate, useful venturi effect arises within the funnel device 100 and that the vents 130 efficiently disperse all of the high velocity air. Various different taper angles 408 and taper lengths 410 are possible and included in the scope of the present invention.

Advantageously, the design of the funnel device 100 results in increased speed of the product flow there through, with decreased collision and merging of the products as they pass through the funnel device 100. The novel funnel device 100 provides for a smooth transition of the products from entrance to exit of the funnel device 100, with a reduction in blockages and therefore an increase in efficiency compared to prior art systems. When used in a counting system or machine, the beneficial operation of this funnel device 100 allows the system to meet productivity demand for counting/dispensing of products with a gelatinous nature, such as soft gels, hard gels, gummies and chewables, into containers of smaller sizes and reduced packaging, which would be impossible with the prior art chute and funnel design.

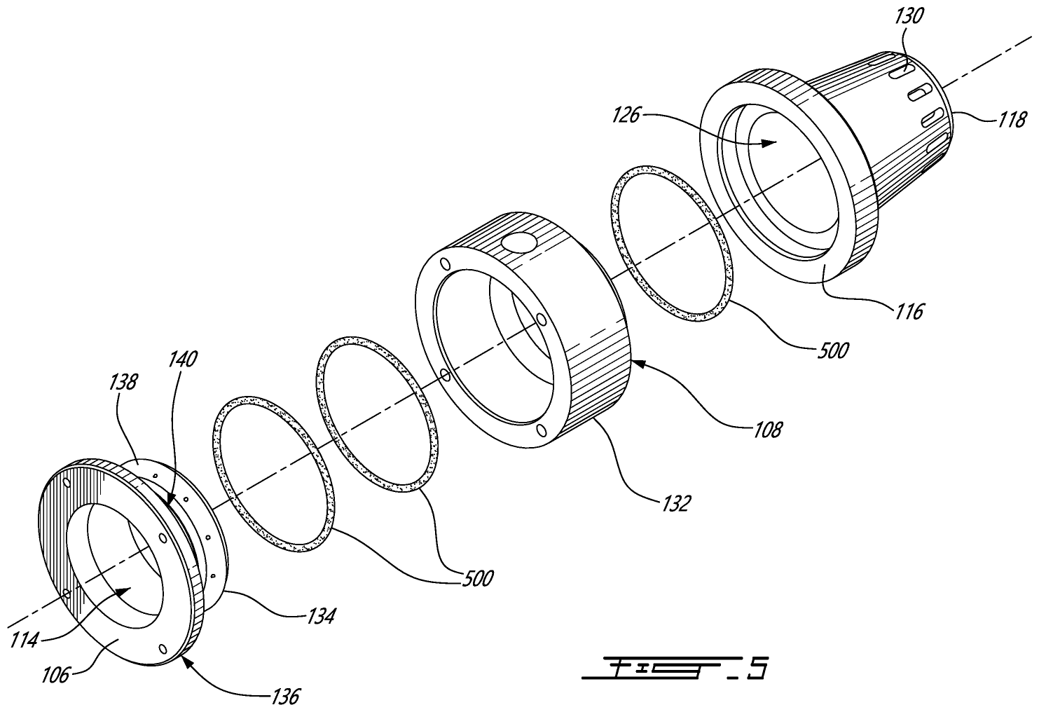

In a specific, non-limiting example of implementation, the cylindrical body portion 102 of the funnel device 100 is formed of two mating components, as shown in the exploded view of FIG. 5 and the cross-sectional views of FIGS. 4A, 4B. More specifically, the cylindrical body portion 102 comprises a ring portion 132 and a cap portion 134. The ring portion 132 defines the lower end 108 of the cylindrical body portion 102, while the cap portion 134 defines the upper end 106 of the cylindrical body portion 102. The cap portion 134 comprises an upper lip 136 and an annular wall 138 extending therefrom, the annular wall 138 defining a groove 140 that runs along its outer surface. When assembled, the annular wall 138 of the cap portion 134 is matingly received inside of the ring portion 132, and the cap portion 134 and ring portion 132 together define the interior surface 110 and exterior surface 112 of the cylindrical body portion 102, as shown in the cross-sectional view of FIG. 4B. Furthermore, when the cap portion 134 and the ring portion 132 are matingly engaged, the groove 140 and an inner surface of the ring portion 132 together define the enclosed annular channel 400 that extends around the cylindrical body portion 102 between its interior and exterior surfaces 110, 112. As discussed above, this annular channel 400 within the cylindrical body portion 102 acts as an air reservoir/plenum, receiving air from a pressurized air supply via the at least one inlet port 128 and evenly distributing this air among the plurality of outlet ports 402.

In assembly, the ring portion 132 and cap portion 134 are mechanically joined together or attached. Note that different mechanisms for connecting or attaching the cap portion 134 to the ring portion 132 are possible. Examples of such mechanisms include rivets, bolts, screws, adhesive, among other possibilities. Note that it is possible for one same mechanism to connect or attach not only the cap portion 134 to the ring portion 132, but also to connect the cylindrical body portion 102 (formed of the mating cap portion 134 and ring portion 102) to the funnel portion 104 of the funnel device 100. Furthermore, in the non-limiting example of implementation shown in FIG. 5, the ring portion 132 and cap portion 134 are sealed together using a series of O-rings 500, also used to seal together the cylindrical body portion 102 and the funnel portion 104 of the funnel device 100.

Various materials, and combinations of materials, may be used in the construction of the funnel device 100, where these materials can be selected to suit the application. Such materials may include metallic materials, such as steel, alloy steel, stainless steel, iron, titanium, etc. Other possible materials include plastic materials, such as polyethylene, polypropylene, polycarbonate, etc. A plurality of different materials and combinations of materials are possible and included in the scope of the invention.

In a specific, non-limiting example of implementation, the materials used for the funnel device 100 are approved materials for food and pharmaceutical contact. Thus, the cylindrical body portion 102 of the funnel device 100 is manufactured from stainless steel (e.g. 316L) while the funnel portion 104 is made of a food-grade plastic, such as acetal, polypropylene, polyethylene terephthalate or high density polyethylene.

Note that, in addition to the importance of suitable materials used in the construction of the funnel device 100, certain surfaces of the funnel device 100 may also require a degree of surface finish or roughness, also determined to suit the application. In a specific, non-limiting example of implementation, during construction and assembly of the funnel device 100, the interior surface 110 of the cylindrical body portion 102 and the inner side 122 of the funnel portion 104 are machined to a surface finish/roughness equal or better than 1.6 um. This ensures not only the hygienic constructions of the funnel device 100 but also that the passage of the high velocity air through the device 100 is not disturbed or interrupted.

The pressurized air supply received at the at least one inlet port 128 of the funnel device 100 is a controlled, clean flow of compressed air (i.e. pressurized to greater than atmospheric pressure). This air flow may be supplied by one or more sources of pressurized air, which are connected to the at least one inlet port 128 and controlled by a controller that controls the air flow delivered to the inlet port 128 by the source of pressurized air. In another example, the pressurized air supply may be received from one or more air filter regulators, themselves connected to compressed air supplies and controlled by a controller.

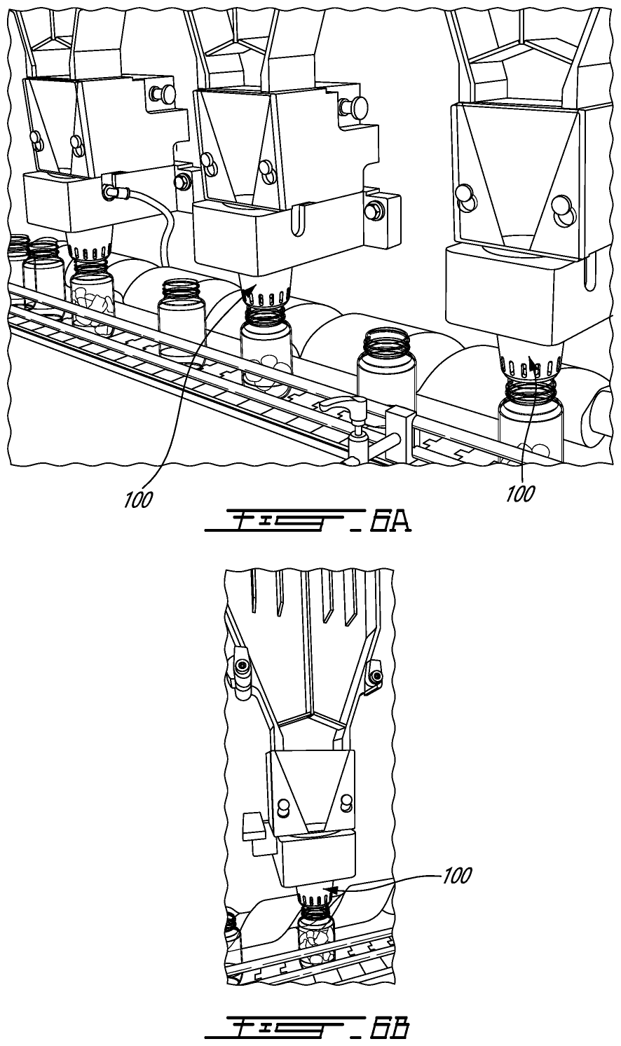

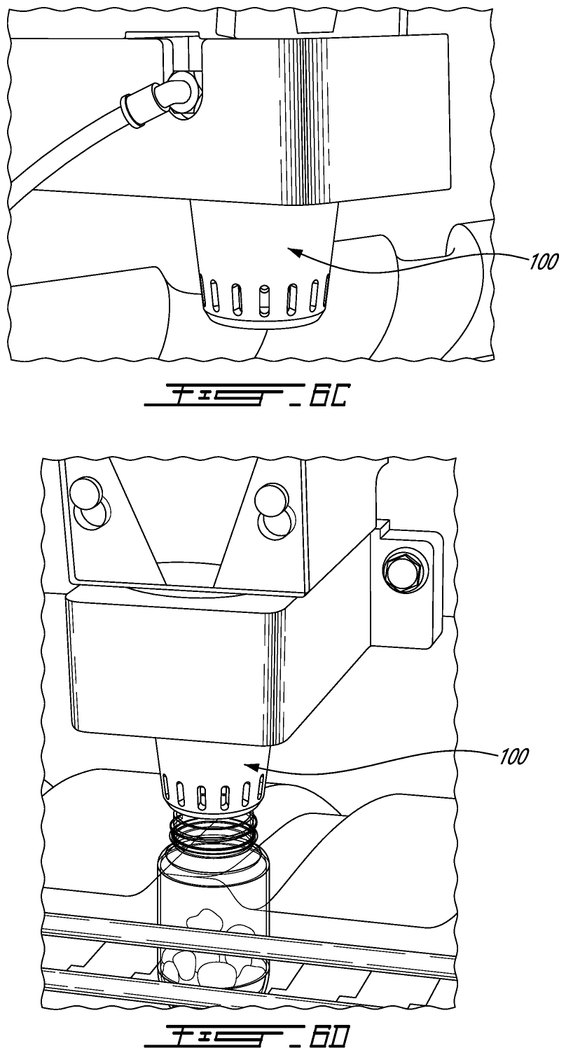

FIGS. 6A-6D illustrate a counting machine for dispensing pharmaceutical products, where this machine incorporates the funnel device 100 of the present invention, according to a specific, non-limiting example of implementation. In this example, gummies are being distributed and transported along a plurality of channels, from a plurality of different starting positions, to chutes leading to a single discharge position. At this discharge position, the funnel device 100 receives the gummies, arriving from different positions, and passes them through into a waiting bottle that has been conveyed along a track to a position directly below the funnel device 100. With activation of the pressurized air supply injected into the funnel device 100, the design of the funnel device 100 and its resulting Venturi effect speed up the flow of the gummies, and mitigate the collisions and merging of the gummies, as they pass through the funnel device 100 and into the waiting bottle. As a result, the counting machine is characterized by reduced blockages/stoppages and greater efficiency and productivity than prior art machines.

In another specific, non-limiting example of implementation, the operation of the counting machine controls the activation/deactivation (sequencing) of the pressurized air supply fed to the inlet port 128 of each funnel device 100. Thus, the Venturi-based operation of a particular funnel device 100 is synchronized and controlled by the counting machine's discharges, switching on automatically to accelerate the flow of products passing there through into a waiting bottle, switching off automatically when there is no product flow through the funnel device 100. In one example, a processor or control unit of the counting machine instructs the controller controlling the source(s) of pressurized air to activate or deactivate the pressurized air supply received at the inlet port 128 of each funnel device 100, on a basis of the product discharges to occur at the discharge position of the machine. Such an automated activation/deactivation feature can be enabled or disabled in software within the processor or control unit of the counting machine, depending on the different packaging configurations implemented by the counting machine (e.g. types/sizes of the mouths of the bottles/containers and/or nature of the products being counted/dispensed).

Although various embodiments have been illustrated, this was for the purpose of describing, but not limiting, the present invention. Various possible modifications and different configurations will become apparent to those skilled in the art and are within the scope of the present invention, which is defined more particularly by the attached claims.

1. A funnel device for a counting system, said funnel device comprising:
a. a hollow cylindrical body portion comprising an upper end, a lower end, an exterior surface and an interior surface, the upper end of said cylindrical body portion operative to receive a plurality of products, the interior surface of said cylindrical body portion defining a first passageway between the upper and lower ends of said cylindrical body portion through which pass the received products;
b. a tapered funnel portion comprising a top end, a bottom end and an annular peripheral wall, the top end of said funnel portion connected to the lower end of said cylindrical body portion, the annular peripheral wall comprising an inner side and an outer side and extending with a taper angle from the top end of said funnel portion to the bottom end thereof, the inner side of the annular peripheral wall defining a second passageway through which pass the products, the bottom end of said funnel portion operative to output the products into a container positioned below said funnel device;
c. at least one inlet port and at least two outlet ports in said cylindrical body portion, said at least one inlet port adapted to receive a pressurized air supply, each of said at least two outlet ports operative to inject a respective air flow into the first passageway proximate to the lower end of said cylindrical body portion and to direct the respective air flow downwardly into the second passageway of said funnel portion, wherein the directed air flows create a venturi effect in said funnel device whereby a speed of flow of the products is increased and a rate of collision of the products is decreased as the products pass through said funnel device;
d. a plurality of vents in said funnel portion, each one of said plurality of vents extending between the inner and outer sides of the annular peripheral wall, wherein said plurality of vents are operative to exhaust the air flows from the second passageway of said funnel portion before the air flows reach the bottom end of said funnel portion.

2. A funnel device as defined in claim 1, wherein said cylindrical body portion further comprises an annular channel extending along a circumference of said cylindrical body portion between said interior and exterior surfaces, said at least one inlet port leading into said annular channel, each of said at least two outlet ports being in fluid communication with said annular channel, said annular channel operative to receive pressurized air of the pressurized air supply via said inlet port and to evenly distribute the pressurized air to the at least two outlet ports.

3. A funnel device as defined in claim 2, wherein said interior surface of said cylindrical body portion defines an angled surface proximate to the lower end of said cylindrical body portion, each outlet port directing the respective air flow onto said angled surface for deflection at a port outlet angle downwardly into the second passageway of said funnel portion.

4. A funnel device as defined in claim 3, wherein the port outlet angle defined by said angled surface is between 10 and 90 degrees.

5. A funnel device as defined in claim 4, wherein the port outlet angle is 30.75 degrees.

6. A funnel device as defined in claim 1, wherein said at least two outlet ports are distributed in a spaced-apart manner about the circumference of said cylindrical body portion.

7. A funnel device as defined in claim 1, wherein the annual peripheral wall of said funnel portion is also characterized by a taper length, a degree of the venturi effect created in said funnel device being dependent on both said taper angle and said taper length.

8. A funnel device as defined in claim 7, wherein said taper angle of said funnel portion is between 10 and 30 degrees.

9. A funnel device as defined in claim 7, wherein said taper length of said funnel portion is at least 70 mm.

10. A funnel device as defined in claim 7, wherein said vents in the annual peripheral wall of said funnel portion extend toward the bottom end of said funnel portion, said vents also being characterized by said taper angle.

11. A funnel device as defined in claim 10, wherein said vents are evenly distributed in a spaced-apart manner about the annular peripheral wall of said funnel portion.

12. A funnel device as defined in claim 11, wherein said vents are located in the annual peripheral wall adjacent to the bottom end of said funnel portion.

13. A funnel device as defined in claim 10, wherein an effectiveness of said vents to exhaust all air of the airflows out of the second passageway is dependent on both said taper angle and said taper length of said funnel portion.

14. A funnel device as defined in claim 2, wherein said cylindrical body portion of said funnel device is formed of two mating components, a ring portion and a cap portion.

15. A funnel device as defined in claim 14, wherein said ring and cap portions together define said annular channel located between the interior and exterior surfaces of said cylindrical body portion.

16. A funnel device as defined in claim 1, wherein said funnel device is constructed of materials approved for food and pharmaceutical contact.

17. A funnel device as defined in claim 16, wherein said cylindrical body portion of said funnel device is made of stainless steel.

18. A funnel device as defined in claim 16, wherein said funnel portion of said funnel device is made of food-grade plastic.

19. A counting system for dispensing pharmaceutical products, said system including a plurality of channels transporting the products from a plurality of different starting positions to a single discharge position, wherein said counting system comprises at said discharge position a funnel device as defined in claim 1 for receiving the products from the plurality of channels.

20. A counting system as defined in claim 19, wherein said counting system controls an activation or a deactivation of the pressurized air supply fed to the at least one inlet port of said funnel device, whereby the venturi effect created in said funnel device can be automatically synchronized and controlled by product discharges of the counting system.
